(19) United States
(12) Patent Application Publication
(10) Pub. No.: US 2007/0143539 A1
(43) Pub. Date: Jun. 21, 2007

(54) Information recording/reproducing apparatus and method for processing read/write command thereof

(75) Inventor: Norimoto Ichikawa, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storages, Inc., Tokyo (JP)

(21) Appl. No.: 11/488,544

(22) Filed: Jul. 17, 2006

(30) Foreign Application Priority Data
Dec. 15, 2005 (JP) 2005-361669

(51) Int. Cl. G06F 13/00

(52) U.S. Cl. 711/113

(57) ABSTRACT

In an information recording/reproducing apparatus 500, enabling to record/reproduce information onto/from an optical disk medium 301 by means of an optical head 508 and execute commands including Write/Read command from a host computer 200 through an interface controller 502, a buffer memory 503 is provided as a cache for storing therein data to be written/readout, temporarily, wherein determination is made on whether function corresponding to the command is in delay or not, when receiving the write/read command from said upper apparatus, and as a result thereof, when the function is determined to be in delay, data transmission speed from the cache is lowered, thereby preventing the apparatus from falling within the time-out of OS, due to delay in Write/Read operation in the drive side, accompanying with comeback from a sleeping condition, etc.

### BACKGROUND OF THE INVENTION

The present invention relates to an information recording/reproducing apparatus for recording/reproducing information onto/from an optical information recording medium, and in particular, it relates to a method for processing read/write command, which is provided from a host side within such apparatus.

In recent years, advances are made, in particular, in optical information recording media, such as, CD (a Compact Disk) and DVD (a Digital Versatile Disk), etc., for example, enabling to record information at high density thereof, and on the other hand, accompanying with such development in high density recording of information on a side of such the medium, also advances are made in speed-up on a drive side, i.e., for an information recording/reproducing apparatus for enabling to record/reproduce information onto/from such the optical information recording medium.

And, accompanying with such speed-up of the rotation speed thereof, in the DVD drive, for example, there are necessities of times for conducting a spin-up process (i.e., for increasing speed), in more details, when coming back from a sleep condition up to a twelve-speed (12× speed), and further the times for exchanging between CAV (Constant Angular Velocity) and CLV (Constant Linear Velocity). For that reason, for the apparatus, it takes times for starting up the read/write operation. And, with such the increases of times up to the time when starting the read/write operation, in some cases, it exceeds an allowable period of time, i.e., a time-out (for example, 7.5 seconds) provided by the OS (Operating System) for processing the read/write command, and thereby brining about a drawback of lowering performances, in particular, in data transmission thereof.

Then, conventionally, an optical disk drive is already known, for example, in the following Patent Document 1, wherein controlling is made on the drive side for the system, in which the time-out is provided in relation to the command processing by the OS. Thus, a timer is provided within the disk apparatus for determining the condition of a cache memory, thereby reporting an error to the host when it is impossible to deal with the request of a command within a time limit of that timer.

Also, in the following Patent Document 2, for example, is disclosed a technology, for improving or increasing an efficiency in use of the cache memory, without taking the time-out determined for the command processing by the OS into the consideration thereof, but for the purpose of preventing the cache from falling into a condition of so-called cache-full, wherein it is determined if the record command of the host is a random recording request or a sequential recording request, so as to conduct recording on the disk.

Patent Document 1: Japanese Patent Laying-Open No. 2001-357619 (2001); and

Patent Document 2: Japanese Patent Laying-Open No. 2005-216431 (2005).

### BRIEF SUMMARY OF THE INVENTION

However, with such the conventional arts mentioned above, and in particular, in the former one, there is provided the timer for measuring or counting up a predetermined time-limit, which is allowed for processing the read-out, as well as, the cache memory provided for storing data read out from the optical disk, temporarily, so as to determine on if there is data or not, to be read out into that cache memory, responding to the read-out request from the host system. And, if determining that there is such data, the data of the cache data is transmitted to the host computer without using the timer means, but if determining there is no data within the cache memory, then it is further determined on whether the time necessary for processing the read-out exceeds or not the predetermined time limit. As a result thereof, the data is transmitted to the host if it is determined not exceed, while on the other hand, an error is reported to the host if it is determined it exceeds that.

Namely, with this, it is impossible to deal with an increase of times for starting up or initiating the read/write operation on the drive side, which are caused due to times necessary for the spin-up and the process for exchanging between the CAV and the CLV, etc., as was mentioned above. In particular, with a high-speed DVD-RAM 12×, the spin-up time grows up, from the condition of stopping the spindle up to the maximum speed, and therefore it exceeds the time period of the time-out, in particular, when the command reaches thereto during that time period.

Also, with the conventional art of the latter mentioned above, not achieving such the object of the present invention, but in other words, it is achieved to make an improvement in efficiency of using the cache memory, by executing the disk recording upon basis of the kind of the recording command provided from the host. With this, therefore, it is also impossible to deal with such an increase in time for starting the read/write operation, including the spin-up time and the process for exchanging the speed between CAV/CLV, as was mentioned above, i.e., the drawbacks to be dissolved by the present invention.

Then, according to the present invention, accomplished by taking the drawbacks of the conventional arts mentioned above into the consideration thereof, an object thereof is to provide an information recording/reproducing apparatus enabling to prevent the read/write command provided by the host side from falling into the time-out of the OS, due to such delays in the read/write operation on the drive side, e.g., the spin-up (i.e., speed increase) from the sleep condition and so on, as was mentioned above, and also a method for processing such the read/write command therefor.

For accomplishing the object mentioned above, according to the present invention, first of all, there is provided an information recording/reproducing apparatus, comprising: an optical head enabling to record/reproduce information onto/from an optical disk medium; an interface controller circuit for transmitting commands, including write/read command, between an upper apparatus; a buffer memory for data of said command therein, temporarily; and a controller for controlling operations of said information recording/reproducing apparatus, wherein further, said controller is so constructed to perform the following operations: determining on whether function corresponding to the command is in delay or not, when receiving the write/read command from said upper apparatus; and lowering data transmission speed from said buffer memory, when the function is determined to be in delay by means of said determination mentioned above.

Also, for accomplishing the object mentioned above, according to the present invention, there is further provided a method for processing write/read command within an information recording/reproducing apparatus, comprising: an optical head enabling to record/reproduce information onto/from an optical disk medium; an interface controller circuit for transmitting commands, including write/read command, between an upper apparatus; a buffer memory for data of said command therein, temporarily; and a controller for controlling operations of said information recording/reproducing apparatus, comprising the following steps of: determining on whether function corresponding to the command is in delay or not, when receiving the write/read command from said upper apparatus; and lowering data transmission speed from said buffer memory, when the function is determined to be in delay by means of said determination mentioned above.

Further, according to the present invention, within the information recording/reproducing apparatus or the method for processing write/read command thereof, preferably, the lowering data transmission speed is executed on all of the write/read commands, which are issued from said upper apparatus, and in such case, preferably, a delay of about one (1) second is inserted into the data transmission when conducting the lowering data transmission speed.

Also according to the present invention, within the information recording/reproducing apparatus or the method for processing write/read command thereof, preferably, the lowering data transmission speed is executed on part of the write/read commands, which are issued from said upper apparatus. Or, preferably, the lowering data transmission speed is executed on a first command of the write/read commands, which are issued from said upper apparatus, and in such case, preferably, a delay of about six (6) second is inserted into the data transmission when conducting the lowering data transmission speed.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the brief structures of an optical disk apparatus, according to an embodiment of the present invention;

FIG. 2 is a flowchart for showing an example of the processes upon a read/write command, in particular, a write command, within the optical disk apparatus mentioned above;

FIG. 3 is a flowchart for showing an example of the processes upon a read/write command, in particular, a read command, within the optical disk apparatus mentioned above;

FIGS. 4(A) and 4(B) are explanatory views for explaining the principle of processes for the read/write command, according to the embodiment of the present invention;

FIGS. 5(A) and 5(B) are also explanatory view for explaining the principle of processes for the read/write command, but according to other embodiment of the present invention; and

FIGS. 6(A) and 6(B) are explanatory view for explaining the principle of processes for the read/write command, in an ordinary optical disk apparatus.

### DETAILED DESCRIPTION OF THE INVENTION

Hereinafter, embodiments according to the present invention will be fully explained by referring to the drawings attached herewith.

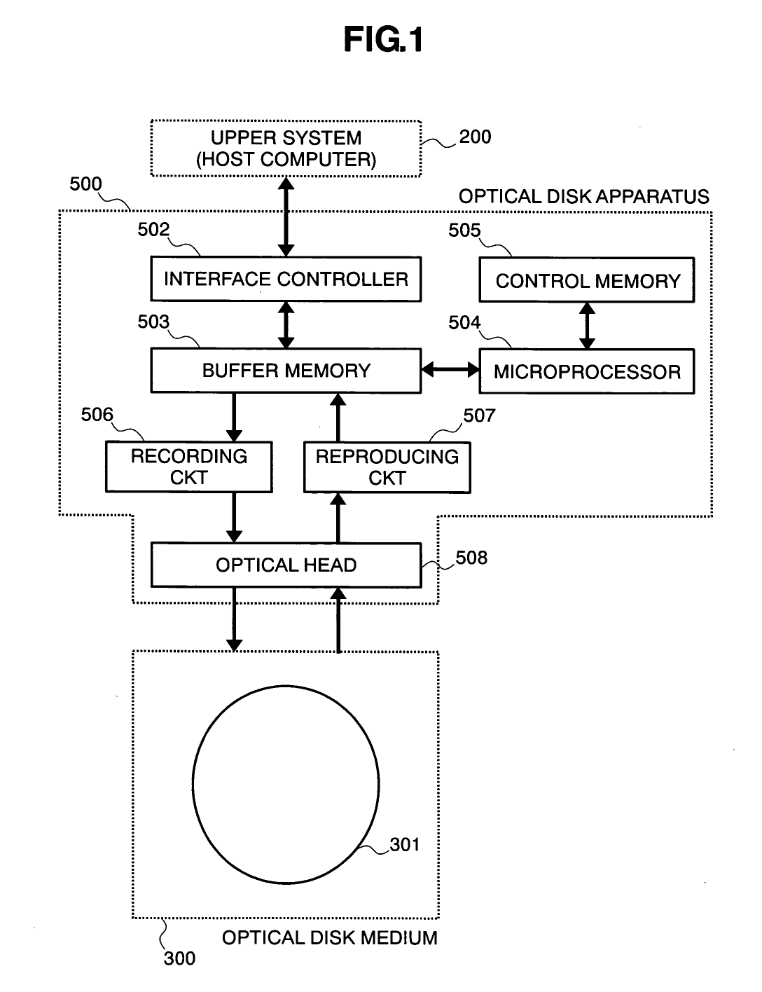

FIG. 1 is a block diagram for showing the structures of a DVD-RAM recording/reproducing apparatus, for example, as the information recording/reproducing apparatus (i.e., an optical disk apparatus), according to an embodiment of the present invention.

In this FIG. 1, there is shown an upper system or apparatus (e.g., a host computer) 200, which may be built up with a personal computer, for example, and from this host computer 200 are issued various commands, including Read/Write command, etc., therein.

On the other hand, a reference numeral 300 shown below in the figure depicts an optical information recording medium, and in more details thereof, an optical disk medium 301, such as, a medium of DVD-RAM, for example. Further, as is indicated by arrows in that figure, this optical disk medium 301 is made chargeable/dischargeable (or loadable/unloadable) into/from the optical disk apparatus 500, e.g., a DVD-RAM recording/reproducing apparatus. With this, recording/reproducing of information can be carried out thereon/from. And, as is apparent from the figure, this optical disk apparatus 500 comprises therein an interface controller 502, as an interface being connectable to the host computer 200, and also an optical head 508. Further, this optical head 508 can move the position thereof with respect to the optical disk medium 301, and also it irradiates a light (for example, a laser light from a laser diode) through an optic system upon an information recording surface thereof, so as to detect a reflection light upon it; thereby, recording or reproducing information upon/from the information recording surface thereof.

Further, this optical disk apparatus 500 comprises a reproducing circuit 507 for inputting a signal reproduced from the optical head 508, and a recording circuit 506 for outputting a signal to be recorded to the optical head 508, wherein the reproducing circuit 507 and the recording circuit 506 are connected with the interface controller 502 through a buffer memory 503. And, within this optical disk apparatus 500, there is further provided a controller means for controlling the entire of the said apparatus, which comprises a control memory, such as, a high-speed IC memory, as well as, a microprocessor 504, therein.

Namely, within the optical disk apparatus, the structures of which are mentioned in the above, a request that is issued from the upper system or apparatus 200 mentioned above, i.e., a Write/Read command, first, it is received (or inputted) by the interface controller 502 of the apparatus, and is transmitted into the microprocessor 504 provided within an inside thereof. And, in case when the command issued from the upper apparatus 200 is a recording request, i.e., the Write Command, the microprocessor 504 gives an instruction through the interface controller 502, so as to transmit the data, recording of which is requested, into the buffer memory 503. Further, the microprocessor 504 transmits the recording data from the said buffer memory 503 to the recording circuit 506.

Thereafter, the microprocessor 504 gives an instruction of encoding to the recording circuit 506, and with this, the recording circuit 506 conducts the encoding process upon the data, recording of which is requested, on the buffer memory 507. Then, the microprocessor 504 gives an instruction to the recording circuit 506, so that it records the data, upon which the encoding is completed, at a predetermined position on the optical recording medium 301. With this, the recording circuit 506 conducts the recording at the predetermined position on the optical recording medium 301.

On the contrary to that, in case where a request that is issued from the upper apparatus 200 is a request of reproducing, i.e., a Read command, the microprocessor 504 gives an instruction to the reproducing circuit 507 mentioned above, so that it reads out the data from a predetermined position on the optical disk medium 301. With this, the reproducing circuit 507 stores the data, which is reproduced from predetermined position on the optical disk medium 301 through the optical head 508, into the buffer memory 503, which is connected to that reproducing circuit 508. And, if there is an error in the reproduced data, then said reproducing circuit 507 conducts error correction process thereon. Then, the microprocessor 504 carries out the operation of transmitting the reproduced data, upon which the error correction is completed, from the buffer memory 503 through the interface controller 502 to the upper apparatus 200.

Thus, with the optical disk apparatus according to the present invention, the data to be written onto or reproduced from (Writhe/Read), responding to a command provided from the upper system or apparatus 200 through the optical head 508, is once accumulated or stored within the buffer memory 503, which functions as a cache memory, while the data read out (or reproduced) is transmitted to the upper apparatus 200 through the interface controller 502, and on the other hand, the data transmitted from the upper apparatus 200 is written (or recorded) onto the optical disk medium through the optical head 508.

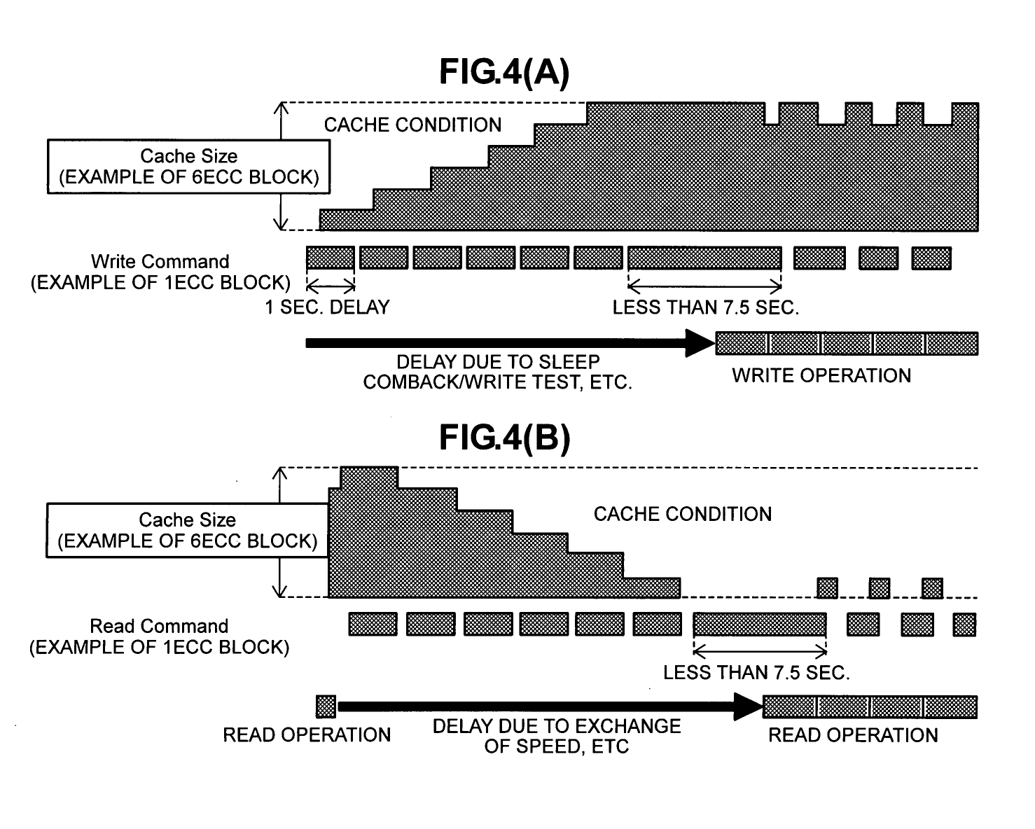

Next, explanation will be given hereinafter, upon the principle of avoiding the time-out of the Write/Read Command through the processing method, according to the present invention, by referring to FIGS. 4 to 6 attached herewith.

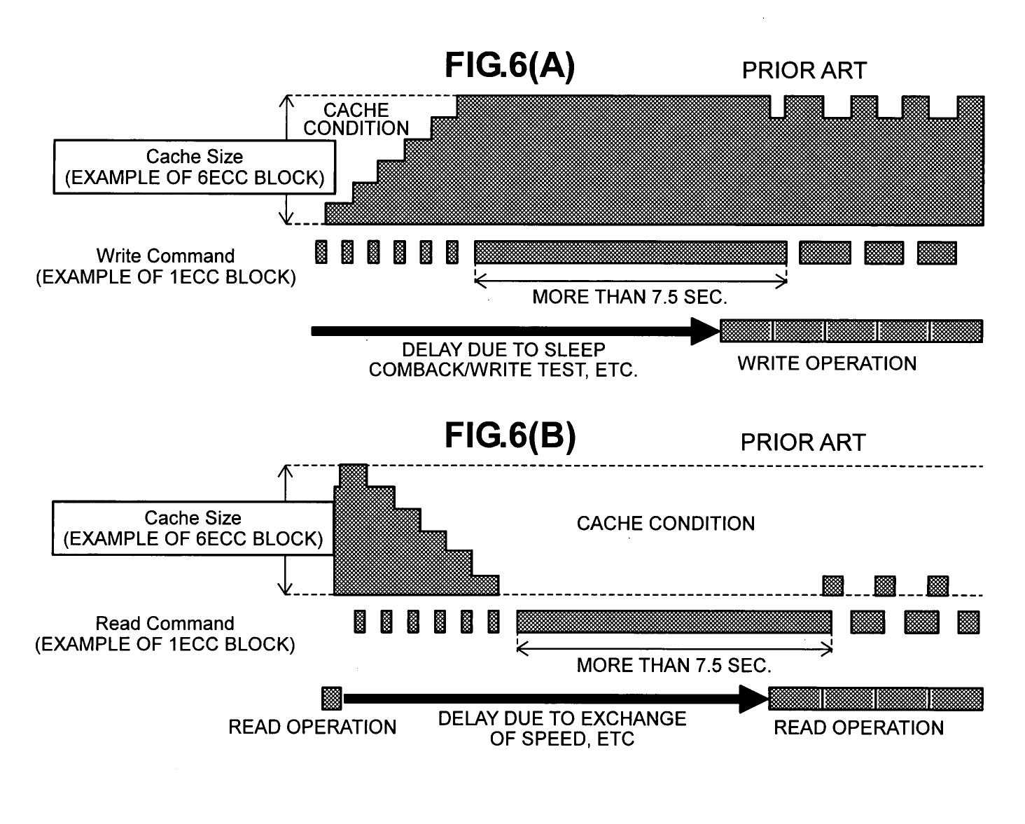

First of all, FIG. 6 attached herewith shows the principle in that processing on the command issued from the upper apparatus 200 is delayed, in general, within the optical disk apparatus; i.e., the Write/Read Command is delayed in the processing thereof, in particular, due to “delay due to sleep comeback/write test” and/or “delay due to exchange of speed”.

However, herein “delay due to sleep comeback/write test” mentioned above means the delay, which is resulted from the time up to when the optical disk apparatus starts the Write/Read operation; i.e., for example, since being in Sleep condition (or in a pause), for that reason, the apparatus must stop the Write/Read function (i.e., make inoperable) so as to come back from the Sleep condition into Standby condition, upon generation of the Write/Read command, due to various adjusting processes including therein, for example, the spin-up (i.e., increasing speed) and write test, etc. Also, “delay due to exchange of speed” mentioned above means the delay, which is resulted from the time when the apparatus stops (or interrupts) the Write/Read function due to the reason for exchanging the rotation speed of the disk, up to the time when the Write/Read operation is started again thereafter.

FIG. 6(A) shows the principle, in particular, when the processing made upon the Write/Read command from the host computer exceeds the period of the time-out of the OS (for example, 7.5 sec.), due to the above-mentioned “delay due to sleep comeback/write test” (during this time period, the Write operation is stopped), and FIG. 6(B) shows the principle, in particular, when the processing made upon the Read command from the host computer exceeds the period of the time-out of the OS (for example, 7.5 sec.), due to the “delay due to exchange of speed” (during this time period, the Read operation is stopped). Also herein, the delays in processing upon the Write command and the Read command mean the conditions where the optical disk apparatus 500 cannot execute transmission of data responding to the command from the upper apparatus 200, due to stoppage of the Read operation and the Write operation thereof.

And, upper in FIG. 6(A) is shown the condition (i.e., a cache condition) of the cache memory (an example of cache size=(6 ECC block)), which builds up portion of the butter memory 507 mentioned above, and wherein a hatched or meshed part in that figure depicts a portion where data is recorded within the memory capacity of the said cache (or, an occupied portion), while an un-hatched or un-meshed part depicts a portion where no data is recorded therein (or, an empty or vacant portion). Also, middle in the figure is shown the generating condition of the Write command, which is generated from the host computer. And, below in the figure is shown the condition of the Write operations within the optical disk apparatus.

And, in a normal operation, as is indicated by an arrow, since no write operation is conducted from the optical disk apparatus 500 onto the optical disk medium 301 during the time-period of “delay due to sleep comeback/write test”, as is shown in the upper portion of the figure, the occupied portion of the cache goes up (i.e., the empty memory portion or capacity thereof is decreased), accompanying with generation of the Write commands from the host computer, and at the end, the entire capacity of the cache is occupied (i.e., no vacancy is remained within the memory capacity). For this reason, as is shown below in the figure, processing is stopped upon the Write command (in this example, the 7^{th} Write Command), and thereafter this sometimes exceeds the time period (for example, 7.5 sec.) of the time-out of the OS mentioned above.

However thereafter, in actual, as is shown in an upper stage of the figure, the optical disk apparatus 500 completes the processes including the spin-up therein, so as to start the Write operation, again, and therefore vacancy is created within the cache. With this, as is shown in the lower stage in the figure, processing is conducted upon the Write command, again. However, in any case, the time for processing is delayed upon the Write command from the host computer, and if it exceeds the time period (for example, 7.5 sec.) of the time-out of the OS, then it results into an error, or the transmission mode is exchanged from DMA into PIO; i.e., performances of the drive is falls down, extremely, thereafter.

Then, according to the present invention, as is shown in FIGS. 4(A) and 4(B), during the time period of the “delay due to sleep comeback/write test” or “delay due to exchange of speed” mentioned above (i.e., the time period indicated by an arrow in the figure), a speed for receiving/transmitting data on the cache is decelerated or lowered down, comparing to the normal one when receiving the Write/Read command from the host computer, in other words, conducting the process on the command by taking times much more (i.e., slowly). With doing this, it is possible to delay or extend the time period during when the apparatus comes to be in such condition that it cannot perform the Read or Write operation because of full or empty condition of the cache thereof. And with this, it is possible to shorten the time, during when the Write/Read command issued from the host computer must wait to be processed thereafter, due to stoppage of operations of the apparatus, i.e., so-called the time waiting for command.

Explaining in more details thereof, according to the present invention, during the time period “delay due to sleep comeback/write test” of the optical disk apparatus, as is shown below in FIG. 4(A), the command process is conducted by delaying the speed of data transmission on the cache. With doing this, it is possible to decelerate the speed in increasing the data occupied region (i.e., decreasing in the vacant memory capacity) within the cache, accompanying with generation of the Write commands from the host computer, and therefore, to delay the time period up to the time when the cache is filled up with data (i.e., no memory capacity is remained). With this, finally no empty memory is remained within the cache, and if delay is caused in the processing of the Write command (i.e., the 7^{th} Write command), but after elapsing time period “delay due to sleep comeback/write test” (the time period indicated by the arrow in the figure), the optical disk apparatus 500 comes back from the sleeping condition, to start the Write operation. Thus, empty is created within the cache, again, and as is shown in middle of the figure, processing is conducted upon the Write command, again. For this reason, there is no chance that the Write command, i.e., the 7^{th} Write command is so delayed in the processing thereof that it exceeds the time period (for example, 7.5 sec.) of the time-out of the OS.

In other words, during the time period “delay due to sleep comeback/write test” shown by the arrow, since there is necessity of times much more than the normal time, for processing the Write command from the host computer, therefore the time point when delay starts on the command comes to be late comparing to the normal, which would be inherently inputted at a time point prior thereto and delayed in the processing thereof, i.e., the 7^{th} Write command, (please see the middle in FIG. 6(A)). For this reason, the time period up to the time when the process is completed thereafter is shortened, as is shown middle in the figure, because of re-opening of the Write operation; i.e., it is possible to bring the time period to be less or shorter than the time period (for example, 7.5 sec.) of the time-out of the OS.

Also, in the example shown in FIG. 4(B), during the time period “delay due to exchange of speed” (i.e., the time period indicated by an arrow in the figure), the speed is also decelerated or lowered down, in increasing of the vacant memory capacity in the cache (i.e., decreasing in the region occupied by data read out from the optical disk medium 301), by decelerating the processing speed of the Read command, and therefore, the time period is delayed up to the time when delay is caused in the processing on the Read command after the cache comes to be empty. With this, no such delay is caused exceeding the time period of time-out (for example, 7.5 sec.) of the OS, in particular, in the processing upon the Read command from the host computer, i.e., the 7^{th} Read command in this example. In other words, during the time period “delay due to exchange of speed” shown by the arrow, since there is necessity of times much more than the normal time, for processing the Write command from the host computer, therefore the time point when delay starts on the command comes to be late comparing to the normal, which would be inherently inputted at a time point prior thereto and delayed in processing thereof, i.e., the 7^{th} Write command, (please see the middle in FIG. 6(B)). For this reason, the time period up to the time when the process is completed thereafter is shortened, as is shown middle in the figure, because of re-opening of the Write operation; i.e., it is possible to bring the time period to be less or shorter than the time period (for example, 7.5 sec.) of the time-out of the OS.

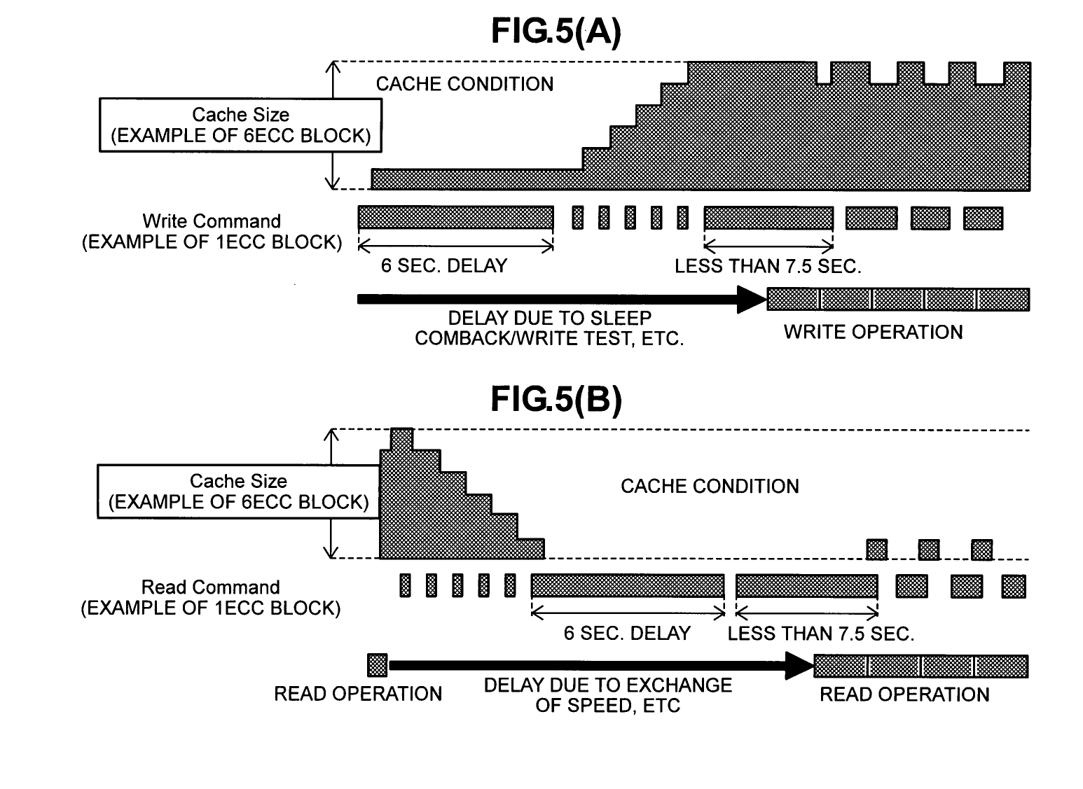

However, in the example mentioned, explanation was given that all of the Write/Read commands from the host computer are processed with delay of around one (1) second, for example, during the time period “delay due to sleep comeback/write test” or the time period “delay due to exchange of speed”; however, the present invention should not be restricted only to this, but other than that, for example, it is also possible to process only a portion of the Write/Read command with delay, which is issued from the host computer during the said time period, as is shown in FIGS. 5(A) and 5(B) below.

Thus, in FIG. 5(A), only the first Write command is processed with delay of around six (6) seconds, among the Write commands, which are issued from the host computer during the time period “delay due to sleep comeback/write test”. However, it can be seen that there can be obtained effect(s) similar to that obtainable with the method shown in FIG. 4(A) mentioned above.

Also, in FIG. 5(B), only the first Read command when the cache comes to be empty in the condition is processed with delay of around six (6) seconds, among the Read commands, which are issued from the host computer during the time period “delay due to exchange of speed”. However, it can be seen that effect(s) can be obtained similar to that obtainable with the method shown in FIG. 4(B) mentioned above. Also, according to the present invention, in case when applying the methods shown in FIGS. 5(A) and 5(B), it is also possible to conduct the processing with delay at desire, not restricted only to the first Write/Read command from the host computer, but also on other command(s).

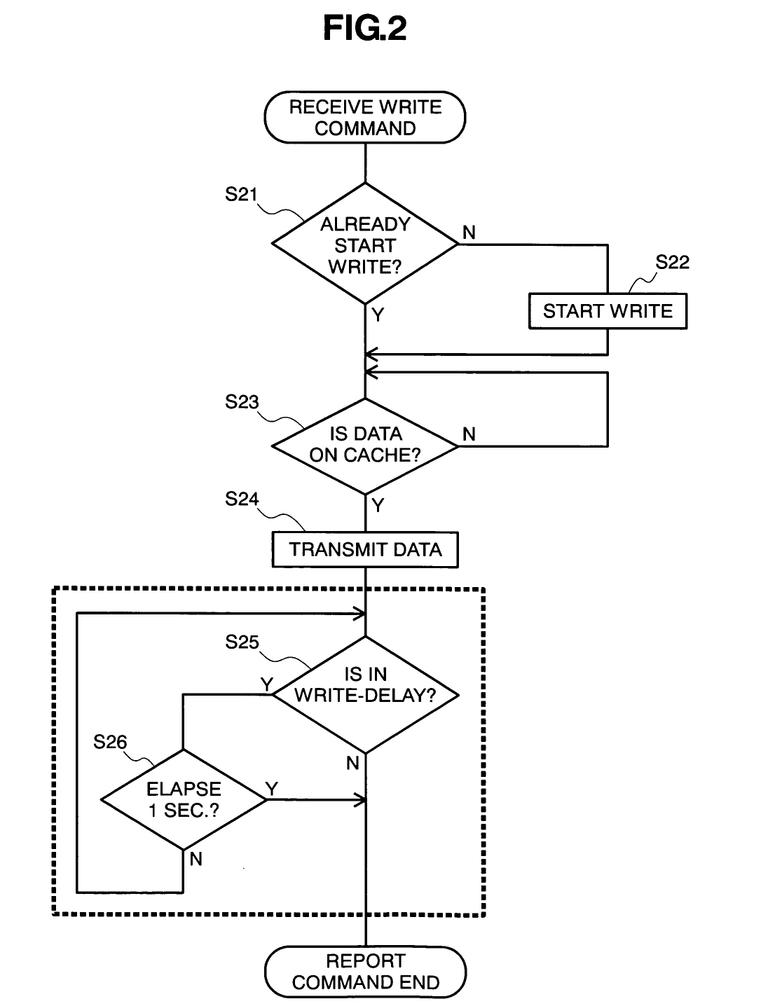

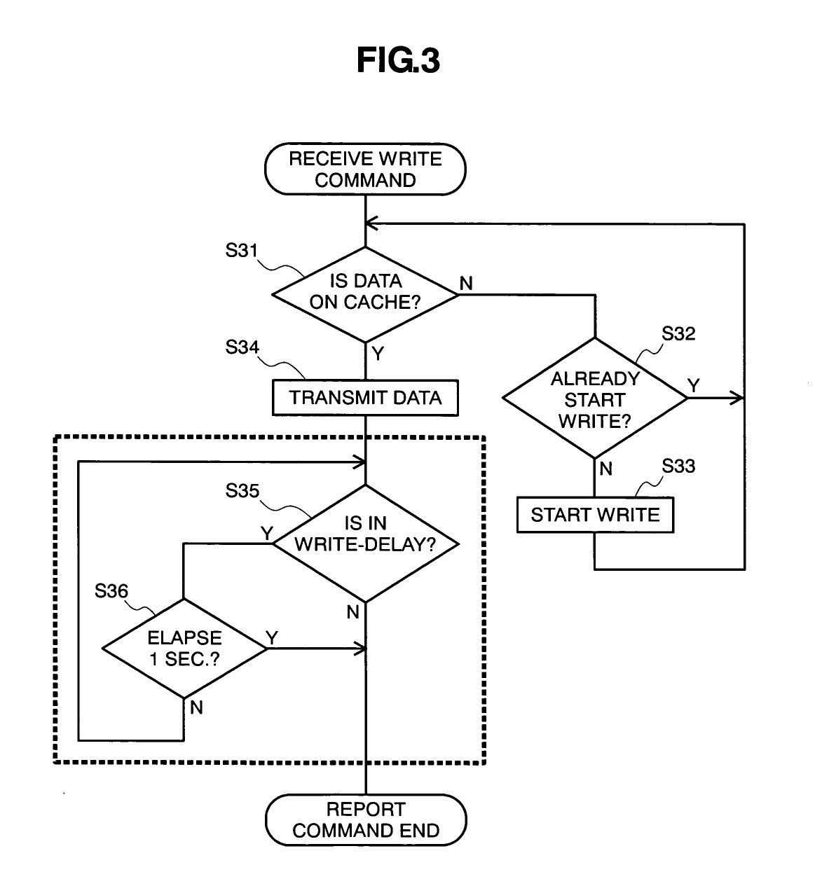

Next, explanation will be made about the detailed method for conducting the processing upon the Write/Read command, according to the present invention, by referring to FIGS. 2 and 3 attached herewith. However, FIG. 2 shows the processes, in particular, in case when the Write command is issued from the host computer, while FIG. 3 shows the processes in case when the Read command is issued therefrom. Further, those processes may be executed by means of the microprocessor 504, being the controller means of the optical disk apparatus 500 shown in FIG. 1 mentioned above.

First of all, the interface controller 502 of the apparatus starts the present processes when receiving the Write command from the host computer. Thus, as is shown in FIG. 2, it is determined on whether the Write operation was already started or not (S201). As a result thereof, if it not yet started (“N” in the figure), the Write operation is started (S202). Further, it is determined on whether the data to be written onto the optical disk medium 301 by the said Write command is on the cache or not, which is constructed within the buffer memory 503 mentioned above (S203), and this is repeated until when determination is made that the data is on the cache. Thereafter, preparation is made on the data on the cache, for transmission to the optical head 508 through recording circuit 508, and it is executed (S204). Then, the data is written at a predetermined position on the optical disk medium 301 through the optical head 508, to complete the Write command, and information is reported about the completion of the command to the host computer side. This is a general flow of the processes for processing the Write command.

According to the present invention, in addition to the series of processes mentioned above, in particular, after preparation of the data transmission (S204), determination is made on whether the apparatus is “in Write delay” or not (S205). However, herein, “in Write delay” has the same meaning to the time period “delay due to sleep comeback/write test”, which is indicated by the arrow in FIG. 4(A) mentioned above. And, as a result of this determination, if it is determined that it is “in Write delay” (“Y”), for example, accompanying an elapse of one (1) second (inserting delay) (S206), writing of data is conducted at the predetermined position on the optical disk medium 301 by means of the optical head 508, and thereafter reporting the completion of the command to the host computer side, as was mentioned above. On the other hand, when it is determined that the apparatus is not “in Write delay” (“N”), as the result thereof, transmission is executed, immediately, so that it is written by the optical head 508 at the predetermined position on the optical disk medium 301, and thereafter, the completion of the command is reported to the host computer side, as was mentioned above.

On the other hand, when the interface controller 502 of the apparatus receives the Read command from the host computer, it starts the present processes. Thus, determination is made on whether the data, on which the Read operation is requested, is on the cache or not, which is constructed with the buffer memory 503 (S301). As a result thereof, in case that it is not (“N”) on the cache, determination is made on whether the Read operation was already started or not (S302), and if necessary, that Read operation is started (S303). Repeating those processes until when it is determined that the data is on the cache (“Y”) in the process S301 mentioned above. Thereafter, in case when it is determined that the data is on the cache (“Y”), the data is prepared for transmission to the host computer through the interface controller 502, to be executed (S304). Then, after reporting the completion of the Read command, and thereby finishing the series of those processes. This is a general flow of the processes for processing the Write command.

According to the present invention, in addition to the series of processes mentioned above, in particular, after preparation of the data transmission (S304), determination is made on whether the apparatus is “in Read delay” or not (S305). However, herein, “in Read delay” has the same meaning to the time period “delay due to exchange of speed”, which is indicated by the arrow in FIG. 4(B) mentioned above. And, as a result of this determination, if it is determined that it is “in Read delay” (“Y”), for example, accompanying an elapse of one (1) second (inserting delay) (S306), transmission of the data is conducted to the host computer through the interface controller 502 mentioned above, and reporting is made about the completion of the command to the host computer side, as was mentioned above. On the other hand, when it is determined that the apparatus is not “in Read delay” (“N”), as the result thereof, the data transmission is executed, immediately, and thereafter, the completion of the command is reported to the host computer side, as was mentioned above.

As was fully explained in the above, according to the present invention, there can be obtained superior effects of providing the information recording/reproducing apparatus enabling to prevent or inhibit the read/write command provided by the host side from falling into the time-out of the OS, due to such delays in the read/write operation on the drive side, e.g., the spin-up (i.e., speed increase) from the sleep condition and so on, as was mentioned above, and also the method for processing such the read/write command therefor.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An information recording/reproducing apparatus, comprising:
an optical head enabling to record/reproduce information onto/from an optical disk medium;
an interface controller circuit for transmitting commands, including write/read command, between an upper apparatus;
a buffer memory for data of said command therein, temporarily; and
a controller for controlling operations of said information recording/reproducing apparatus, wherein
further, said controller is so constructed to perform the following operations:
determining on whether function corresponding to the command is in delay or not, when receiving the write/read command from said upper apparatus; and
lowering data transmission speed from said buffer memory, when the function is determined to be in delay by means of said determination mentioned above.

2. The information recording/reproducing apparatus, as described in the claim 1, wherein the lowering data transmission speed is executed on all of the write/read commands, which are issued from said upper apparatus.

3. The information recording/reproducing apparatus, as described in the claim 2, wherein a delay of about one (1) second is inserted into the data transmission when conducting the lowering data transmission speed.

4. The information recording/reproducing apparatus, as described in the claim 1, wherein the lowering data transmission speed is executed on part of the write/read commands, which are issued from said upper apparatus.

5. The information recording/reproducing apparatus, as described in the claim 1, wherein the lowering data transmission speed is executed on a first command of the write/read commands, which are issued from said upper apparatus.

6. The information recording/reproducing apparatus, as described in the claim 5, wherein a delay of about six (6) second is inserted into the data transmission when conducting the lowering data transmission speed.

7. A method for processing write/read command within an information recording/reproducing apparatus, comprising:
an optical head enabling to record/reproduce information onto/from an optical disk medium;
an interface controller circuit for transmitting commands, including write/read command, between an upper apparatus;
a buffer memory for data of said command therein, temporarily; and
a controller for controlling operations of said information recording/reproducing apparatus, comprising the following steps of:
determining on whether function corresponding to the command is in delay or not, when receiving the write/read command from said upper apparatus; and
lowering data transmission speed from said buffer memory, when the function is determined to be in delay by means of said determination mentioned above.

8. The method for processing write/read command within an information recording/reproducing apparatus, as described in the claim 7, wherein the lowering data transmission speed is executed on all of the write/read commands, which are issued from said upper apparatus.

9. The method for processing write/read command within an information recording/reproducing apparatus, as described in the claim 8, wherein a delay of about one (1) second is inserted into the data transmission when conducting the lowering data transmission speed.

10. The method for processing write/read command within an information recording/reproducing apparatus, as described in the claim 7, wherein the lowering data transmission speed is executed on part of the write/read commands, which are issued from said upper apparatus.

11. The method for processing write/read command within an information recording/reproducing apparatus, as described in the claim 7, wherein the lowering data transmission speed is executed on a first command of the write/read commands, which are issued from said upper apparatus.

12. The method for processing write/read command within an information recording/reproducing apparatus, as described in the claim 11, wherein a delay of about six (6) second is inserted into the data transmission when conducting the lowering data transmission speed.
